(19) United States
(12) Patent Application Publication
(10) Pub. No.: US 2007/0146857 A1
(43) Pub. Date: Jun. 28, 2007

(54) TORSIONAL HINGE MIRROR ASSEMBLY WITH REDUCED FLEXING

(75) Inventors: John Walter Orcutt, Richardson, TX (US); Andrew Steven Dewa, Plano, TX (US); Arthur Monroe Turner, Allen, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Plano, TX (US)

(21) Appl. No.: 11/614,191

(22) Filed: Dec. 21, 2006

Related U.S. Application Data
(60) Provisional application No. 60/754,425, filed on Dec. 28, 2005.

(51) Int. Cl. G02B 26/08

(52) U.S. Cl. 359/224; 359/291

(57) ABSTRACT

A torsional hinged mirror assembly having a hinge plate having a central portion and a pair of torsional hinges extending outwardly in opposite directions from the central portion along a first axis and a first pair of support spines extending from the central portion in a second direction substantially perpendicular to the first axis. A mirror plate is attached to the hinge plate and has a reflecting side and a back side, a second pair of support spines located along a perimeter of the back side and extending generally in the second direction, wherein the first pair of support spines on the hinge plate and the second pair of support pines on the mirror plate are aligned and the back side of the mirror plate being attached to the hinge plate.

This application claims the benefit of U.S. Provisional Application No. 60/754,452 filed on Dec. 28, 2005 which is incorporated herein by reference in its' entirety.

### TECHNICAL FIELD

The present invention relates to maintaining a flat reflective surface during the operation of a torsional hinged mirror and more particularly to pivoting torsional hinged mirrors at a high speed.

### BACKGROUND

Pivoting or oscillating torsional hinged mirrors provide very effective yet inexpensive replacements for spinning polygon shaped mirrors in printers and some types of displays. As will be appreciated by those skilled in the art, torsional hinged mirrors may be MEMS type mirrors etched from a silicon substrate using processes similar to those used in the manufacture of semiconductor devices. Earlier versions of torsional hinge mirrors for providing a raster type scan for printers and displays often operated at rotational speeds of about 3 KHz or less. Torsional hinged mirrors operating at 3 KHz or slower can be manufactured thick enough so that they do not demonstrate serious flatness problems with respect to the reflective surface. However, as the demand for higher print speeds and better resolution increased, flatness of the mirror reflective surface has now become a much more serious problem. As the mirror continuously flexes or bends back and forth during the continuous oscillations about the axis, the greatest deformation was at the tip or ends of the flexing mirror. Presently available mirrors have substantially reduced this problem by the use of a hinge plate that includes a center spine that extends along the long axis of the elliptical shaped mirror to each of the tips or ends of the mirror.

Referring now to FIG. 1A, a prior art torsional hinged mirror assembly known from U.S. Pat. No. 6,956,684 issued on Oct. 18, 2005 and having common inventorship with the present application is shown generally as 100. The mirror assembly comprises a mirror 110 supported by torsional hinges 140,142 which are attached to supports 120, 130, respectively. As it is more clearly seen in the enlarged view in FIG. 1B, the mirror 110 has a mirror plate 132 which has a central spine 134 formed on the back side thereof. The support spine 134 is formed by micromachining the back side of the mirror plate 132 by etching, for example. The mirror plate 132 is attached to a hinge plate 144. The hinge plate 144 has a spine 136 which aligns with the spine 134 on the mirror plate 132. Integrally formed with the hinge plate are the torsional hinges 140, 142 which are formed by micromachining silicon, by etching, for example. Attached to the back side of the hinge plate 144 is an optional permanent magnet 138. The permanent magnet can be used to impart the pivoting motion to the mirror assembly 110 or can be used to sense the position of the mirror. A drive coil or sense coil used in conjunction with the magnet to drive the mirror or sense its' position is not shown in the figures but is well known in the prior art. Accordingly, no further explanation needed to be provided here.

Unfortunately, with greater rotational speeds and thinner and smaller mirrors, new flexing modes around the edges now affect the flatness of the mirror during operation. Referring now to FIG. 2A, a torsional hinged mirror assembly to solve this problem and known from U.S. Pat. No. 7,050,211 which was issued on May 23, 2006 having common inventorship with the present application is shown generally as 200. The mirror assembly 200 comprises mirror 210 supported by torsional hinges 250, 252 from supports 220, 230, respectively. FIG. 2B shows an enlarged view of the mirror 210. Mirror 210 comprises a mirror plate 232 which has a central spine 236 and a pair of perimeter spines 234, 238 on the back side thereof. The spines are formed by micromachining the mirror plate 232, by etching, for example. Attached to the back side of the mirror plate 232 is a hinge plate 252 which has torsional hinges 250, 252 formed integral thereof, by micromachining a piece of silicon, for example, such as by etching. Hinge plate 252 has a central spine 242 and a pair of perimeter spines 240, 246 which align with the spines 234, 236, 238 of the mirror plate 232 when the hinge plate and mirror plate are bonded together. The combination of the spines 234, 236, 238 and 240, 242 and 246 provides the support that prevents the flexing of the mirror either at the tips or at the edges so that the mirrors may be made thinner and can be used at higher rotational speeds. In order to utilize a commercially available magnet the optional magnet 48 is inserted into a recess 254 in the hinge plate 252. As with the mirror shown in FIG. 1, the permanent magnet can be used to impart the rotational motion to the mirror or can be used to sense the position of the mirror using a coil in proximity to the magnet (not shown).

Putting the optional magnet 48 in the recess 245 allow for a larger commercially available magnet to be used. However, it creates two additional problems. First of all, it is difficult to get the adhesive for the magnet, such as epoxy glue, into the recess so that the magnet will be aligned and secured therein. Secondly, cutting the recess into the hinge plate 252 reduces the rigidity of the resulting mirror assembly which causes it to flex during operation and delaminate the magnet from the hinge plate. Accordingly, it is desirable to have a solution to reducing the stress on the hinges without creating the problems of retaining the magnet attached to the hinge plate.

### SUMMARY OF THE INVENTION

It is a general object of the present invention to provide a torsional hinge mirror assembly having a low flex at the ends and edges of the mirror and a lower mass without having a recess for the permanent magnet.

This and other objects and features are provided, in accordance with one aspect of the present invention by a torsional hinged mirror assembly comprising a hinge plate having a central portion and a pair of torsional hinges extending outwardly in opposite directions from the central portion along a first axis and a first pair of support spines extending from the central portion in a second direction substantially perpendicular to the first axis. A mirror plate is attached to the hinge plate and has a reflecting side and a back side, a second pair of support spines located along a perimeter of the back side and extending generally in the second direction, wherein the first pair of support spines on the hinge plate and the second pair of support pines on the mirror plate are aligned. The back side of the mirror plate is attached to the hinge plate.

### BRIEF DESCRIPTION OF THE DRAWINGS

FIG. 1A shows a torsional hinge mirror assembly of the prior art, FIG. 1B shows an enlarged view of the mirror assembly of FIG. 1A;

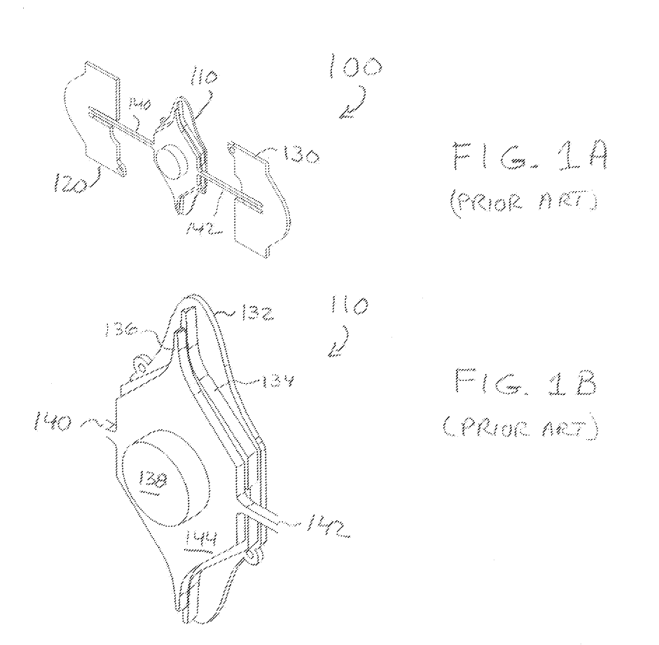

FIG. 2A shows a second torsional hinge mirror assembly according to the prior art, FIG. 2B shows an enlarged view of the torsional hinge mirror assembly of FIG. 2A;

FIG. 3A shows a first embodiment of the present invention, FIG. 3B shows an enlarged view of the mirror assembly of FIG. 3A;

FIG. 4A shows a second embodiment of the present invention, FIG. 4B shows an enlarged view of the mirror assembly of FIG. 4A.

### DETAILED DESCRIPTION

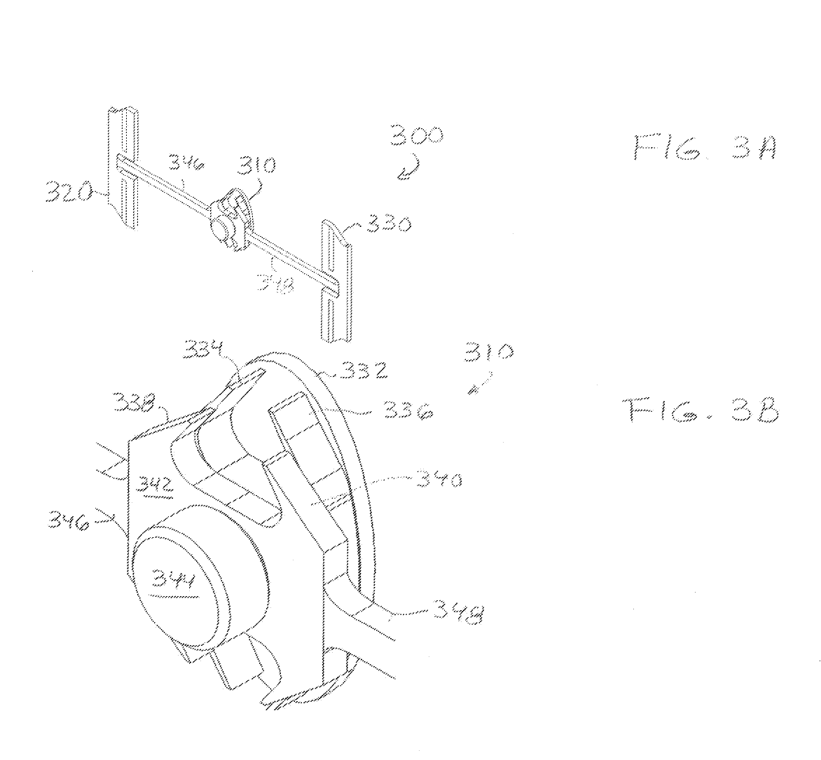

Referring now to FIG. 3A, a torsional hinged mirror assembly accordingly to the present invention is shown generally as 300. The assembly 300 comprises the mirror 310 supported by torsional hinges 346, 348 attached to supports 320, 330, respectively.

The mirror 310 is shown more clearly in the enlarged view of FIG. 3B. The mirror 310 comprises a mirror plate 332 which has a reflecting side and a mounting side. The reflecting side, not shown in FIG. 3B is polished to reflect incident light and may be coated with a metal, such as gold, to improve its' reflectivity. The back side of the mirror plate is micromachined to form spines 334, 336 by micromachining, such as by etching. As is well known in the art the mirror plate 332 maybe manufactured from a single piece of silicon utilizing integrated circuit fabrication techniques. The spines 334, 336 are along the perimeter of the mirror plate 332, although they may point towards the center at the top and bottom edges of the mirror 332, as is shown in FIG. 3B. While the spines, 334, 336 are generally along the mirror plate 332, those skilled in the art recognize that the exact shape of the spine is a design choice which can be varied without departing from the teachings of the present invention.

Attached to the mirror plate 332 is a hinge plate 342 which has torsional hinges 346, 348 formed integrately therewith by micromachining techniques such as etching. The hinge plate 342 and the torsional hinges 346, 348 may be micromachined from a single piece of silicon, for example. The hinge plate 342 has spines 338, 340 which align with the spines 334, 336, respectively, formed on the back of the mirror plate 332. Thus, the combination of spines 334, 338, and 336, 340 support the mirror plate 332 minimizes flexing at the ends of the mirror plate 332 as well as the edges thereof. Optional permanent magnet 344 is attached to the surface of hinge plate 342. No recess for the permanent magnet is required. The elimination of the central spines from the mirror plate 332 and the hinge plate 332 reduces the mass of the overall assembly and thereby eliminates the need for the recess. This provides for a greater stiffness of the assembly and eliminates the problem of getting an adhesive, such a epoxy glue, into the recess to retain the permanent magnet. As described above, and is well known in the prior art, the permanent magnet can be used with a coil (not shown) to either impart oscillatory motion to the mirror assembly or to sense the position of the mirror. If the coil and magnet assembly is used to sense the position of the mirror, other drive methods such as piezoelectric can be employed as is well known in the art.

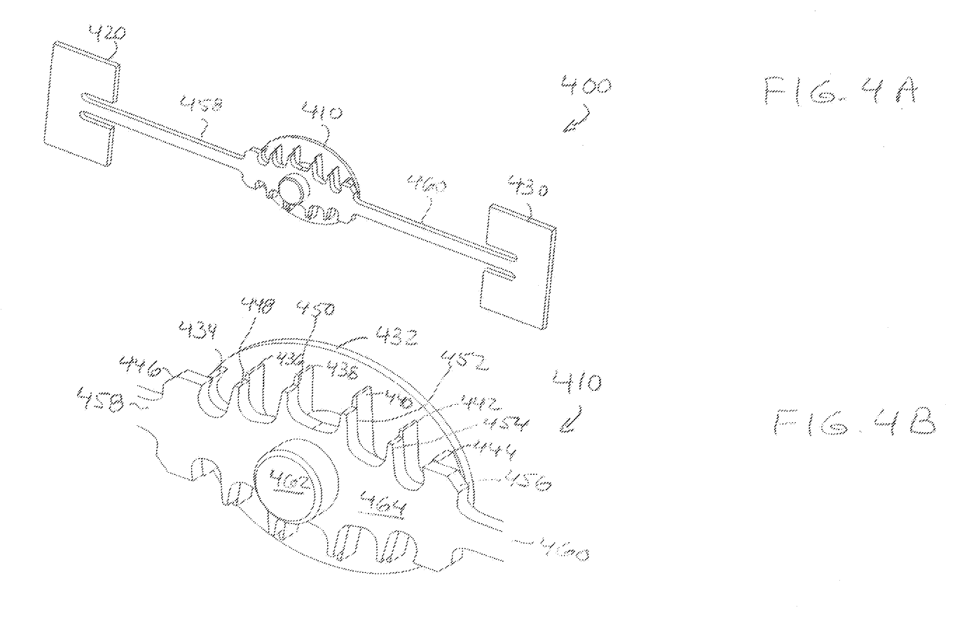

A second embodiment of the present invention is shown in FIG. 4A generally as 400. The torsional hinged mirror assembly 400 comprises mirror 410 which is supported by torsional hinges 458, 460 attached to supports 420, 430, respectively. In this embodiment the mirror 410 is wider than the mirror 310 shown in the embodiment of FIGS. 3A and 3B. This relatively wider mirror necessitates additional support along the back side of the mirror to prevent excessive flexing during operation.

FIG. 4B is an enlarged view of the mirror 410 shown in FIG. 4A. As can be seen in FIG. 4B, the mirror plate 432 has a plurality of spines 434, 436, 438, 440, 442, 446 formed along the width thereof. These spines are formed in pairs about a central axis of the mirror but no central spine is required. That is, there is no central spine formed along the vertical axis of the mirror plate 432. The spines 434, 436, 438, 440, 442 and 444 are formed along the back side of the mirror plate 432 by micromachining techniques, such as by etching. The mirror plate 442 can be formed from a single piece of silicon, as it is well known in the art. The front surface of the mirror plate 432 is polished to provide a reflecting surface and may be coated with a metallic coating in order to increase its reflectivity. The mirror plate 432 is bonded to a hinge plate 454 which has torsional hinges 458, 460 formed integrately therewith by intergrated circuit manufacturing techniques such as etching. Hinge plate 464 has a plurality of spines 446, 448, 450, 452, 454 and 456 which are formed about vertical central axis of the hinge plate 464; no central spine is required. When the mirror plate 432 and hinge plate 464 are bonded together, the ridges 434, 436, 438, 440, 442 and 444 are aligned with the ridges 446, 448, 450, 452, 454, 456, respectively, in order to provide support for the mirror plate to minimize the flexing of the mirror assembly during operation.

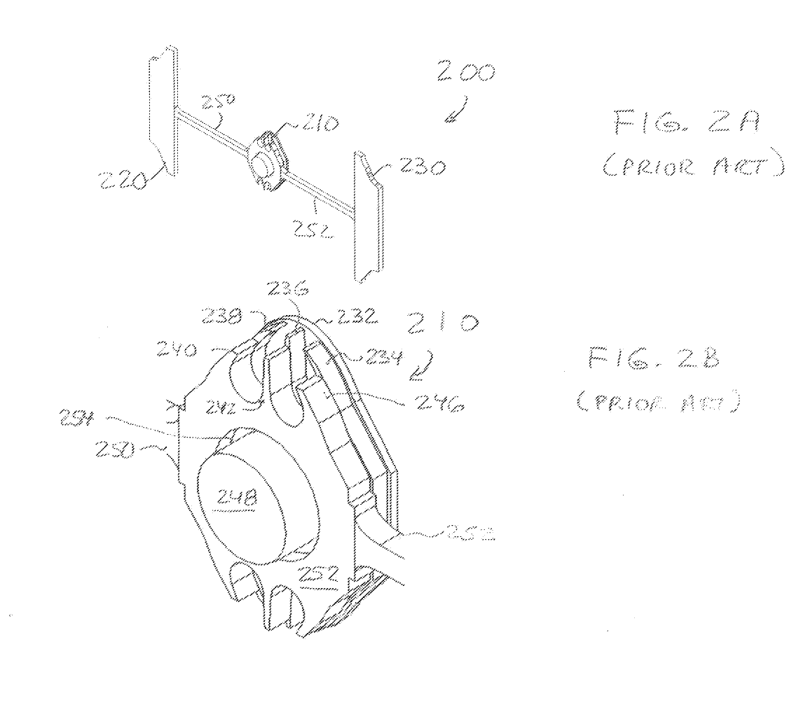

The utilization of a plurality of spines across the width of the mirror provides a structure with a low mass so that the optional permanent magnet 462 can be attached to the back side of hinge plate 464 without the need of recess shown in FIGS. 2A and 2B. Thus, the problems with the structure due to flexing and the placement of the adhesive for holding the permanent magnet 462 to the hinge plate 464 are avoided.

The permanent magnet 462 can be utilized with a coil (not shown) for either driving the mirror or sensing its position as describe above in connection with the embodiments of FIG. 3A and 3B.

The embodiments of the present invention are particularly useful for operating speeds for the mirrors above 20 KHz and are especially useful for mirrors operating at speeds of 30 KHz or more. In addition, if the mirror layer is made even thinner, the present invention maybe advantageous at lower operating speeds.

While the invention has been particularly shown and described with reference to preferred embodiments thereof it is well understood by those skilled in the art that various changes and modifications can be made in the invention without departing from the spirit and scope of the invention as defined by the appended claims.

What is claimed is:

1. A torsional hinged mirror assembly comprising:
a hinge plate having a central portion and a pair of torsional hinges extending outwardly in opposite directions from the central portion along a first axis and a first pair of support spines extending from the central portion in a second direction substantially perpendicular to the first axis;
a mirror plate attached to the hinge plate and having a reflecting side and a back side, a second pair of support spines located along a perimeter of the back side and extending generally in the second direction, wherein the first pair of support spines on the hinge plate and the second pair of support pines on the mirror plate are aligned;
the back side of the mirror plate being attached to the hinge plate.

2. The torsional hinged mirror assembly of claim 1 wherein the first pair of support spines are located on a perimeter of the hinge plate.

3. The torsional hinged mirror assembly of claim 1 further comprising a permanent magnet mounted to an opposite side of the hinge plate from the first pair of support spines.

4. The torsional hinged mirror assembly of claim 2 further comprising a permanent magnet mounted to an opposite side of the hinge plate from the first pair of support spines.

5. The torsional hinged mirror assembly of claim 3 wherein the permanent magnet is surface mounted on the hinge plate.

6. The torsional hinged mirror assembly of claim 4 wherein the permanent magnet is surface mounted on the hinge plate.

7. The torsional hinged mirror assembly of claim 3 further comprising a magnetic coil that interacts with the permanent magnet.

8. The torsional hinged mirror assembly of claim 4 further comprising a magnetic coil that interacts with permanent magnet.

9. The torsional hinged mirror assembly of claim 3 wherein said permanent magnet and said coil provide rotational energy to said mirror member.

10. The torsional hinged mirror assembly of claim 4 wherein said permanent magnet and said coil provide rotational energy to said mirror member.

11. The torsional hinged mirror assembly of claim 9 wherein said mirror assembly oscillates at its resonant frequency.

12. The torsional hinged mirror assembly of claim 10 wherein said mirror assembly oscillates at its resonant frequency.

13. The torsional hinged mirror assembly of claim 7 wherein said permanent magnet and said coil operate as a sensing device.

14. The torsional hinged mirror assembly of claim 8 wherein said permanent magnet and said coil operate as a sensing device.

15. The torsional hinged mirror assembly of claim 1 wherein at least one of said pair of torsional hinges further defines an enlarged area and further comprising a permanent magnet attached to said enlarged area for importing oscillating motion to said mirror assembly.

16. The torsional hinged mirror assembly of claim 7 and further comprising a drive mechanism for importing oscillating motion to said mirror assembly.

17. The torsional hinged mirror assembly of claim 8 and further comprising a drive mechanism for importing oscillating motion to said mirror assembly.

18. The torsional hinged mirror assembly of claim 16 wherein said drive mechanism comprises a piezoelectric unit to impart said oscillating motion to said torsional hinged mirror assembly.

19. The torsional hinged mirror assembly of claim 17 wherein said drive mechanism comprises a piezoelectric unit to impart said oscillating motion to said torsional hinged mirror assembly.

20. The torsional hinged mirror assembly of claim 17 wherein said mirror rotates at its resonant frequency at a speed above 20 KHZ.

21. The torsional hinged mirror assembly of claim 1 further comprising:
a third pair of spines on the hinge plate, the pair of spines being located substantially equidistant from a center of the hinge plate and extending generally in the second direction; and
a fourth pair of spines on the mirror plate, located on the back side thereof, and aligning with the third pair of spines.
